(19) United States
(12) Patent Application Publication
(10) Pub. No.: US 2018/0211062 A1
(43) Pub. Date: Jul. 26, 2018

(54) SELECTIVELY OBSCURING REPRESENTATIVE ATTRIBUTES OF FILES

(71) Applicant: Microsoft Technology Licensing, LLC, Redmond, WA (US)

(72) Inventors: Chase Andrew Holland, Kirkland, WA (US); Andrew Michael Weckstein, Redmond, WA (US); Vincent Henry DeVito, III, Redmond, WA (US)

(21) Appl. No.: 15/416,607

(22) Filed: Jan. 26, 2017

(51) Int. Cl. G06F 21/62; G06F 3/0482; G06F 3/0484

(52) U.S. Cl. CPC G06F 21/6254; G06F 3/04847; G06F 3/0482

(57) ABSTRACT

Systems, methods, and software are disclosed herein for obfuscating representative attributes of files. In an implementation, an application identifies a set of files to make available in a file selector view of a user interface to the application. For at least a file of the set of files, the application identifies an obfuscation group(s) to which the file belongs and produces a representative attribute(s) of the file as specified in metadata for the obfuscation group. The representative attribute of the file may be presented in the file selector view in the user interface to the application.

### TECHNICAL BACKGROUND

Online storage services have grown in popularity and capability to such an extent that they have become a routine part of the information technology landscape for most users. A host of features often accompany such services, including the ability to encrypt or obfuscate the content that is stored in them. While such features provide undeniable benefits to end users, a new problem has become prevalent which may be referred to as the over-the-shoulder problem.

Many users mix their work files with their personal files, or their private files with their public. In any case, the situation often arises where a user is browsing his or her files only to have the thumbnail version of a file or even its name reveal otherwise sensitive information to another person or people nearby.

Thumbnail previews can be turned off or minimized in some file systems, and details hidden, thereby precluding a stray observer from seeing sensitive content. However, such a solution applies to all of the files in a given view—not just a select few. Moreover, such settings are usually local and do not flow from one device to another. Thus, while a user may be protected on one device, the thumbnail images or file name and other sensitive details may surface in full view on the next device.

### OVERVIEW

Technology is disclosed herein that allows end users to selectively obscure representative attributes of their files in a user interface. In an implementation, an application identifies a set of files to make available in a file selector view of a user interface to the application. For at least a file of the set of files, the application identifies an obfuscation group(s) to which the file belongs and produces a representative attribute(s) of the file as specified in metadata for the obfuscation group. The representative attribute of the file may be presented in the file selector view in the user interface to the application.

The foregoing Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational environment and a related operational scenario in an implementation.

FIG. 2 illustrates an attribute obfuscation process in an implementation.

FIG. 3 illustrates an attribute obfuscation process in an implementation.

FIG. 4 illustrates a table design in an implementation.

FIGS. 5A-5D illustrate related operational scenarios in an implementation.

FIGS. 6A-6B illustrate related operational scenarios in an implementation.

FIGS. 7A-7B illustrate related operational scenarios in an implementation.

FIG. 8 illustrates a computing system suitable for implementing the software technology disclosed herein, including any of the applications, architectures, elements, processes, and operational scenarios and sequences illustrated in the Figures and discussed below in the Technical Disclosure.

### TECHNICAL DISCLOSURE

Technology is disclosed herein that allows representative attributes of files to be selectively obscured in a user interface to an application. In a brief example, a user may wish to obscure the various thumbnail images, file names, or other sensitive information that accompanies the views rendered by various applications. In a solution to the over-the-shoulder problem, the user can selectively identify which one or more files to obscure and how to obscure them. The obfuscation configuration can be applied across different devices so that the user's choices on one device flow to the user experience on another.

In an implementation, an application renders a user interface to the application in operation. The application identifies a set of files to make available in a file selector view of the user interface to the application, such as gallery to a photo application, a view of a folder on an online storage service, or a file picker view in an application. For at least a file of the set of files, the application identifies at least an obfuscation group to which the file belongs and produces at least a representative attribute of the file as specified in metadata for the obfuscation group. Finally, the application presents at least the representative attribute of the file in the file selector view in the user interface to the application.

Any suitable application may communicate with an online storage service that stores the files and the metadata for the files and the obfuscation groups. The applications may thus retrieve files, their metadata, and obfuscation group metadata in order to provide a user experience with customized obfuscation of file details. In a technical effect, thumbnails of files may be produced locally to have an obscured effect such that a casual observer (or any observer) is unable to perceive the photo or file behind the thumbnail. Other details may also be obscured, in addition to or in place of thumbnails, such as the name, date, or location associated with a given file. Any type of file may be protected in this manner, including photos, documents, emails, and videos, or any other type of file for which representative attributes may be rendered and displayed in application views.

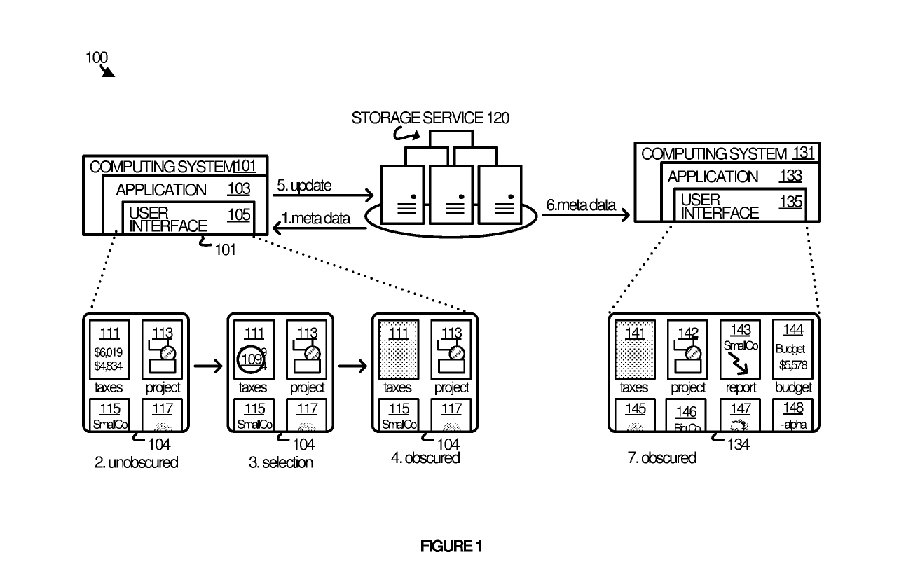

FIG. 1 illustrates an operational environment 100 in an implementation of selectively obscured file attributes. Operational environment 100 includes computing system 101 on which application 103 runs. Application 103 employs an attribute obfuscation process in the context of interfacing with storage service 120 and producing views in user interface 105 to the application (e.g. obfuscation process 200 and/or obfuscation process 300). Operational environment 100 also includes computing system 131 (optional).

Application 103 and application 133 are each representative of any software application or application component capable of selectively obscuring representative attributes of files. Examples of applications 103 and 133 include, but are not limited to, storage applications, productivity applications, email applications, photo gallery applications, gaming applications, or any other type of application. Application 103 and application 133 may each be implemented as a natively installed and executed application, a web application hosted in the context of a browser, a mobile application, a streamed or streaming application, or any variation or combination thereof.

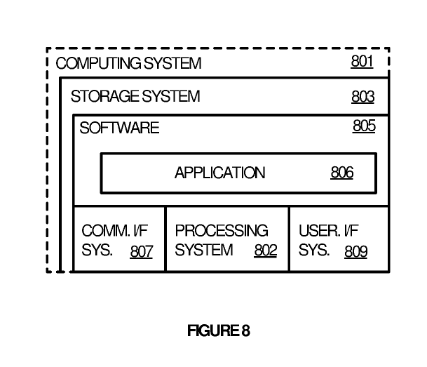

Computing system 101 and computing system 131 are each representative of any computing system capable of running an application natively or in the context of a web browser, streaming an application, or executing an application in any other manner Examples of computing systems 101 and 131 include, but are not limited to, personal computers, mobile phones, tablet computers, desktop computers, laptop computers, wearable computing devices, or any other form factor, including any combination of computers or variations thereof. Computing systems 101 and 131 may each include various hardware and software elements in a supporting architecture suitable for providing application 103 or application 133 respectively. One such representative architecture is illustrated in FIG. 8 with respect to computing system 801.

Storage service 120 is representative of any online service capable of storing files and providing access to the files via client application (e.g. application). Storage service 120 may be implemented in a combination of hardware and software elements in the context of a data center. Storage service 120 may be deployed as an on-premises service, as a cloud storage service that is generally available to users (e.g. individuals, organizations, and enterprises), or in some other manner. A non-limiting example of storage service 120 is the OneDrive® service from Microsoft®. Storage service 120 may be implemented on one or more computing systems, of which computing 801 FIG. 8 is representative.

In operation, storage service 120 stores files for a user, which may be accessed through any of a variety of applications. In order for an application to open a file or for a user to browse his or her files, storage service 120 first provides the applications with metadata that lists the attributes for the user's files. Examples of such attributes include, but are not limited to, file names, created dates, file sizes, unique resource identifiers, thumbnail locations, and so on.

The applications use at least some of the metadata to produce file representations for the user to consider when browsing the files. For example, the applications may produce a view in a user interface that includes thumbnail representations of the files, possibly along with file names or other metadata details for the files. The user may then browse the files, open one or more of the files, or otherwise interact with the view.

In operational environment 100, storage service 120 supplies metadata to application 103. In turn, application 103 produces a view 104 in user interface 105 that includes thumbnail representations of at least some of the files, e.g. thumbnail 111, thumbnail 113, thumbnail 115, and thumbnail 117. The thumbnails themselves include various representative attributes of a given file, such as a thumbnail-sized image and a file name View 104 may be considered a selector view in that the user may select a given file or files when interacting with the view.

At the outset in this scenario none of the thumbnail representations of the files are obscured. However, it may be assumed for exemplary purposes that the user desires to obscure one or more of the representations, so as to avoid the over-the-shoulder problem discussed above. Accordingly, the user makes a selection 109 of thumbnail 111, which triggers application 103 to obscure or otherwise alter the outward appearance of the thumbnail image. Other representative attributes may also be obscured in addition to or in place of the thumbnail image, such as the name of the underlying file. Going forward, the image for thumbnail 111 is obscured either fully or partially.

Application 103 provides an update to storage service 120 so that the file obfuscation can be persisted for subsequent user experiences with respect to user interface 105 but also with respect to other applications on computing system 101 or on other devices, such as computing system 101. Accordingly, storage service 120 also provides metadata to application 133. Application 133 may then present view 134 in user interface 135.

View 134 includes file representations of the same files represented in view 104, although with a few additional files represented due to its larger form factor. View 134 includes thumbnail 141, thumbnail 142, thumbnail 143, thumbnail 144, thumbnail 145, thumbnail 146, thumbnail 147, and thumbnail 148. It may be appreciated that thumbnail 141 has its thumbnail image obscured as a result of the selection 109 made by the user earlier in view 104 with respect to thumbnail 111.

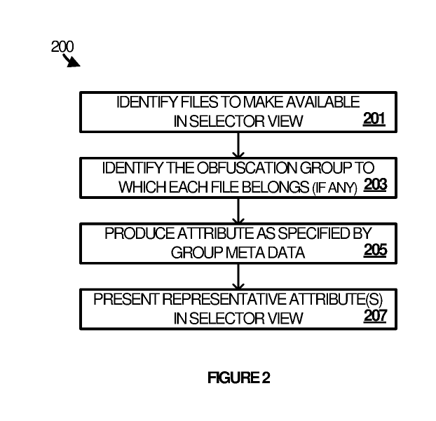

FIG. 2 illustrates a process that may be employed by an application (e.g. application 103 or application 133) to allow representative attributes to be selectively obscured as illustrated in the previous Figure. Some or all of the steps of obfuscation process 200 may be implemented in program instructions in the context of the component or components of the application used to carry out the selective obscuring of representative attributes. The program instructions direct a given application to operate as follows.

First, the application identifies which files to make available in a selector view in a user interface to the application (step 201). This may involve retrieving a file table from an online storage service that lists some or all of the files in a particular account, drive, or folder. In some cases, the list may be filtered based on a date range, location, person, or some other search criteria.

The application processes the files on a per-file basis to identify an obfuscation group to which each file belongs (step 203). Such information may be included in the table retrieved from the online storage service that hosts the files. In other implementations, the application may have to make one or more requests to the online storage service to obtain the group information for each file.

With the files identified and the group information in-hand, the application may then produce representative attributes for the files as-specified by metadata associated with their respective group(s) (step 205). As an example, a given file may belong to one group. The group's metadata may specify that the thumbnail image for any file in the group be obscured. The application would therefore produce an obscured thumbnail image for display in the selector view. The application would proceed file-by-file to determine which attributes—if any—to obscure visually or otherwise. The application may then present the representative attributes in the selector view (step 207). Presenting the representative attributes may involve various steps such as rendering the selector view or directing another component to produce the view. In some cases, such workloads may be offloaded to components that are not part of the application, such as an operating system utility.

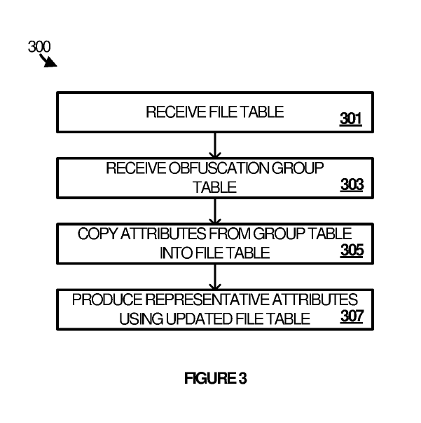

FIG. 3 illustrates another process that may be employed by an application (e.g. application 103 or application 133) to allow representative attributes to be selectively obscured as illustrated in the previous Figure. Obfuscation process 300 may be employed in cooperation with obfuscation process 200 in some implementations, although alternatives to obfuscation process 300 are possible. Some or all of the steps of obfuscation process 300 may be implemented in program instructions in the context of the component or components of the application used to carry out the selective obscuring of representative attributes. The program instructions direct a given application to operate as follows.

To begin, an application receives a file table from an online storage service that stores files that a user may want to browse, open, or otherwise interact with through the application (step 301). The file table may provide a list of files in a particular account, drive, folder, or the like, as well as metadata describing various attributes of the file. Examples of such attributes include, but are not limited to, file names, created dates, file sizes, unique resource identifiers, and thumbnail locations.

Next, the application receives an obfuscation group table (step 303). The obfuscation group table describes which attributes to obscure on a per-group basis. As an example, the metadata for one group may specify that thumbnail images be obscured, while metadata for another specifies that file names be obscured. Metadata for yet another group may specify that both the thumbnail image and the file name be obscured for any file in that group. Other aspects may also be specified in the table, such as the type of authentication or authorization required to remove a file from a group, remove the obscuring effect on any given attribute, or otherwise modify aspects of obfuscation with respect to files in a group.

The application then proceeds to copy the specification information from the group table into the file table on a per-file basis (step 305). The file table is edited to indicate for each file which attribute(s) to obscure—if any. The file table may then be accessed directly by the application when producing the representative attributes of the files (step 307). In this manner, the application may avoid having to consult two tables at run-time when thumbnail images and other such representative attributes are rendered.

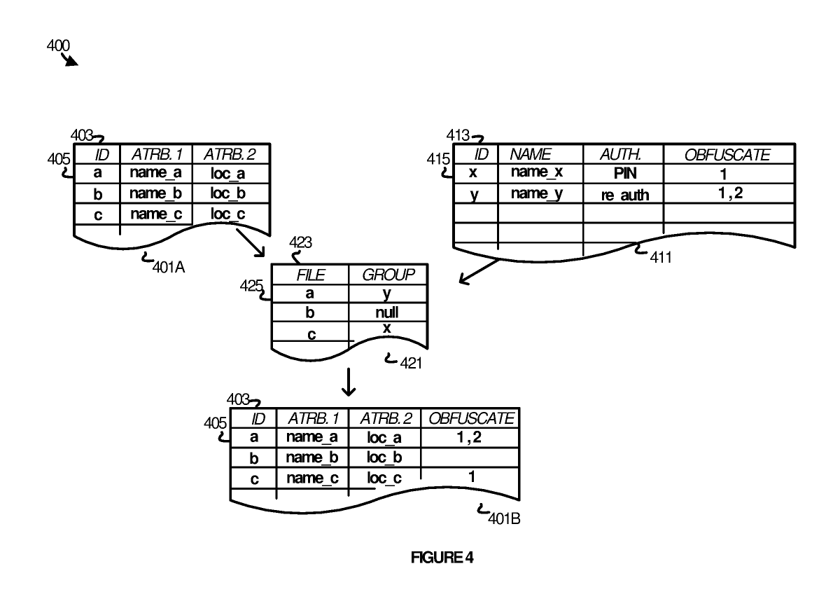

FIG. 4 illustrates a table design 400 in an implementation representative of the tables an application may receive from an online storage service. File table 401A is representative of a file table may include a list of the contents of an account, drive, folder, or other such storage location. File table 401A is defined in terms of columns 403 and rows 405. Each file is listed in a row. The columns in each row provide a file identifier for each file and then various attributes, represented by attribute 1 and attribute 2 in this example, although more attributes are possible. Attribute 1 is the name of a given file while attribute 2 is the location of a thumbnail image for the file.

Group table 411 is representative of a group table that specifies for each obfuscation group which attribute(s) of any file in a group to obscure. Group table 411 is also defined in terms of columns 413 and rows 415. Each group belongs to a row. The columns in each row specify a group identifier, a name of the group, and an authorization mechanism. Additionally, obfuscation instructions are specified. Namely, the attribute or attributes of a file that should be obscured for files in a given group are specified.

Join table 421 is representative of join instructions that that an application may reference in order to edit file table 401A to produce file table 401B. Join table 421 is also defined in terms of columns 423 and rows 425 and associates file identifiers with group identifiers. Join table 421 is maintained separately from file table 401 so that file table 401 in order to maintain compatibility with other applications that do not support obfuscation as described herein.

The application refers to the list in join table 421 in order to determine which group a given file in file table 401A belongs to. The application may then add a column to file table 401A that specifies which attribute(s) of a file to obscure, resulting in a new state of the table represented by file table 401B. The column is populated for a given file by first identifying which group the file belongs to and then ascertaining from group table 411 which attribute to obscure. The identity of the attribute can be copied into file table 401B. The application at run-time may thus refer to only file table 401B in order to determine how to produce the representative attribute(s) of a given file.

Both join table 421 and group table 411 may be changed depending upon user interaction with the application. For example, a user may add or remove a file from a group or the user may change the specifications of an obfuscation group. The changes can be uploaded to the online storage service and distributed to other clients associated with the user so that the same obfuscation applies when the user moves to a different device.

Using the data in FIG. 4 as an example, file table 401A lists three files: a, b, and c. Each have a name attribute that specifies the files name and a location attribute that specifies a thumbnail location. Group table 411 includes two groups: x and y. Group x obfuscates attribute 1 in file table 401, while group y obfuscates both attributes. Join table 421 defines file a as belonging to group y and file c and belonging to group x, while file b belongs to no group (or a null group).

Editing file table 401A in view of group table 411, using join table 421 as a guide, produces file table 401B. File a's record is edited to reflect that both attributes should be obscured; file b's record is edited to reflect that no obfuscation should occur; while file c's record is edited to reflect that the first attribute should be obscured.

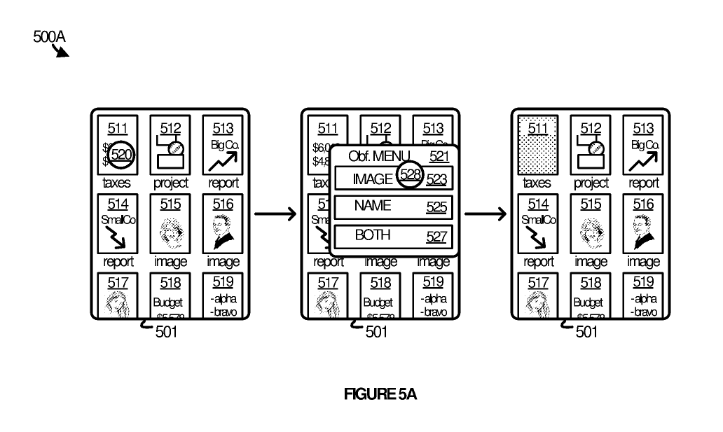

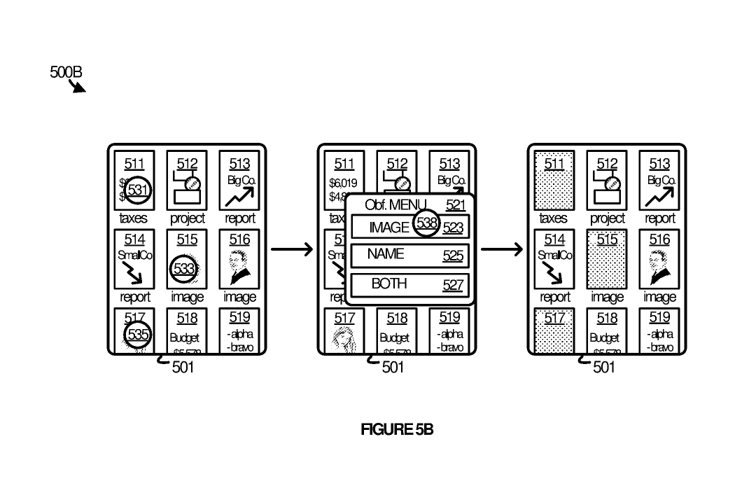

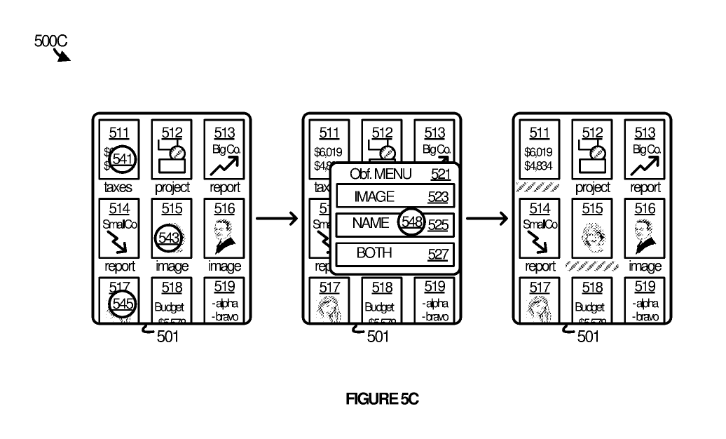

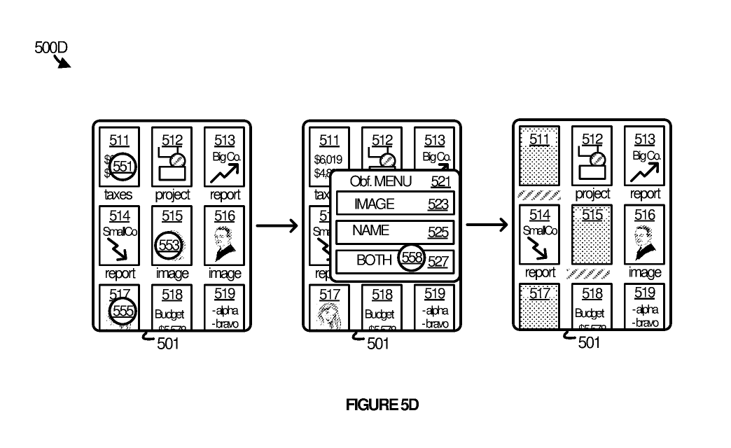

FIG. 5A illustrates an operational scenario 500A in an implementation. In operational scenario 500A, a gallery view 501 of a storage location has been produced by an application (e.g. application 103 or application 133). Gallery view 501 includes various thumbnail representations of files in the storage location, represented by thumbnail 511, thumbnail 512, thumbnail 513, thumbnail 514, thumbnail 515, thumbnail 516, thumbnail 517, thumbnail 518, and thumbnail 519. The thumbnails each include a thumbnail image as well as a name string, both of which are drawn from their respective underlying file.

Initially, none of the thumbnails belong to an obfuscation group. Thus, any observer of the view may be able to see sensitive details in the images or file names. For example, thumbnail 511 relates to a tax document and includes sensitive financial figures in the thumbnail image. Other thumbnails include images of people or documents that the end-user may prefer be obscured. Accordingly, the user makes a selection 520 of one or more of the files, which directly or indirectly results in obfuscation menu 521 surfacing.

Obfuscation menu 521 provides the user with various obfuscation options with respect to the thumbnail 511 that was selected. Image option 523 obscures the thumbnail image; name option 525 obscures the thumbnail name; and the both option 527 obscures both image and the name. Other options in addition to or in place of those shown herein are possible and may be considered within the scope of the present disclosure.

It is assumed for exemplary purposes that the user makes a selection 528 of the image option 523, resulting in the obscuring of the image in thumbnail 511. The image is obscured immediately and the metadata associated with the file linked to thumbnail 511 is updated. The metadata can be uploaded to the online storage service so the same obfuscation is experience during later sessions or on other devices.

FIG. 5B illustrates a similar scenario in operational scenario 500B. In operational scenario 500B, selections are made of multiple thumbnails. Selection 531 selects thumbnail 511; selection 533 selects thumbnail 515; and selection 535 selects thumbnail 517. The user is then navigated to obfuscation menu 521 and proceeds to make a selection 538 of image option 523, which results in the obscuring of the images associated with thumbnail 511, thumbnail 515, and thumbnail 517. The metadata associated with the files linked to the thumbnails may be updated and uploaded to the online storage session to be applied during subsequent sessions or on other devices.

In FIG. 5C, operational scenario 500C depicts a case where three thumbnails are again selected by way of selection 541, selection 543, and selection 545. The user then makes a selection 548 of name option 525, which results in the obscuring of the file names associated with thumbnail 511, thumbnail 515, and thumbnail 517. As with the other scenarios, the metadata associated with the files linked to the thumbnails may be updated and uploaded to the online storage session for use with subsequent sessions or on other devices.

In FIG. 5D, operational scenario 500D depicts a case where multiple obfuscation options are selected and applied to multiple thumbnails. In operational scenario 500D, three thumbnails are again selected by way of selection 551, selection 553, and selection 555. The user then makes a selection 558 of the both option 527, which results in the obscuring of the images and the file names associated with thumbnail 511, thumbnail 515, and thumbnail 517. As with the other scenarios, the metadata associated with the files linked to the thumbnails may be updated and uploaded to the online storage session for use with subsequent sessions or on other devices.

FIG. 600A illustrates an operational scenario 600A in another implementation. In operational scenario 600A, a gallery view 601 of a storage location has been produced by an application (e.g. application 103 or application 133). Gallery view 601 includes various thumbnail representations of files in the storage location, represented by thumbnail 611, thumbnail 612, thumbnail 613, thumbnail 614, thumbnail 615, thumbnail 616, thumbnail 617, thumbnail 618, and thumbnail 619. The thumbnails each include a thumbnail image as well as a name string, both of which are drawn from their respective underlying file.

Initially, none of the thumbnails belong to an obfuscation group. Thus, any observer of the view may be able to see sensitive details in the images or file names. Accordingly, the user makes a selection 620 of one or more of the files, which directly or indirectly results in a groups menu 621 surfacing.

Groups menu 621 provides the user with various obfuscation options with respect to the thumbnail 611 that was selected. Home option 623 assigns the image to a home group for which the user has specified obfuscation parameters or for which a default parameters already exists. Friends option 625 assigns the image to a friends group with obfuscation parameters defined by default or by the user that differ from those of the home group. Work option 627 assigns the image to a work group with obfuscation parameters defined by default of by the user that differ from those of the home group and those of the work group. Other options in addition to or in place of those shown herein are possible and ay be considered within the scope of the present disclosure.

It is assumed for exemplary purposes that the home group specifies that the thumbnail image for a file be obscured. Accordingly, the selection 628 of the home option 623 results in the thumbnail image associated with thumbnail 611 being obscured. The metadata associated with each file can be uploaded to the online storage service so the same obfuscation is experienced during later sessions or on other devices.

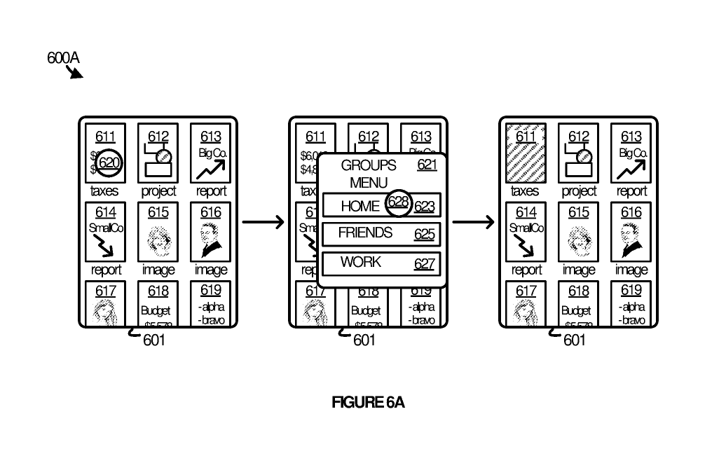

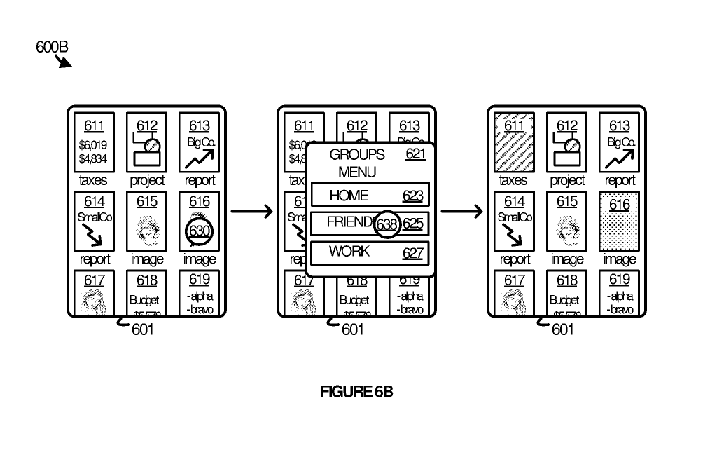

In FIG. 6B, operational scenario 600B is a continuation of operational scenario 600A and demonstrates how the obfuscation effect may vary between groups, to give the user a visual clue as to which group a given thumbnail belongs. A selection 630 is made of thumbnail 616 which results in groups menu 621 surfacing. The user makes a selection 638 of the friends option 625, which results in the thumbnail image associated with thumbnail 616 being obscured. However, the obfuscation effect may differ relative to that of thumbnail 611, as indicated by the different fill patterns. In a real-life scenario, the color of texture of the obscuring may different in an example.

FIG. 700A illustrates an operational scenario 700A in another implementation. In operational scenario 700A, a gallery view 701 of a storage location has been produced by an application (e.g. application 103 or application 133). Gallery view 701 includes various thumbnail representations of files in the storage location, represented by thumbnail 711, thumbnail 712, thumbnail 713, thumbnail 714, thumbnail 715, thumbnail 716, thumbnail 717, thumbnail 718, and thumbnail 719. The thumbnails each include a thumbnail image as well as a name string, both of which are drawn from their respective underlying file.

Initially, none of the thumbnails belong to an obfuscation group. Thus, any observer of the view may be able to see sensitive details in the images or file names. Accordingly, the user makes a selection 720 of one or more of the files, which directly or indirectly results in a groups menu 721 surfacing.

Groups menu 721 provides the user with various obfuscation options with respect to the thumbnail 711 that was selected. Home option 723 assigns the image to a home group for which the user has specified obfuscation parameters or for which a default parameters already exists. Friends option 725 assigns the image to a friends group with obfuscation parameters defined by default or by the user that differ from those of the home group. Work option 727 assigns the image to a work group with obfuscation parameters defined by default of by the user that differ from those of the home group and those of the work group. Other options in addition to or in place of those shown herein are possible and ay be considered within the scope of the present disclosure.

It is assumed for exemplary purposes that the home group specifies that both the thumbnail image and the name string for a file be obscured. Accordingly, the selection 728 of the home option 723 results in the thumbnail image and the name string associated with thumbnail 711 being obscured. The metadata associated with each file can be uploaded to the online storage service so the same obfuscation is experience during later sessions or on other devices.

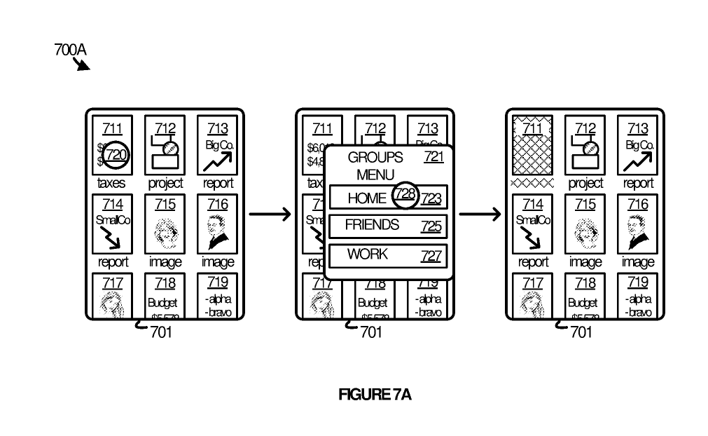

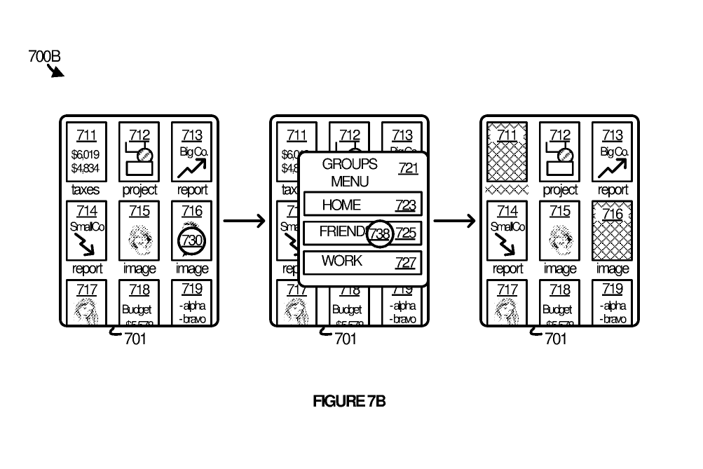

In FIG. 7B, operational scenario 700B is a continuation of operational scenario 700A and demonstrates how obfuscation parameters may vary between groups. A selection 730 is made of thumbnail 716 which results in groups menu 721 surfacing. The user makes a selection 738 of the friends option 725, which results in the thumbnail image associated with thumbnail 716 being obscured. In other words, the obfuscation parameters associated with the friends group differ from those of the home group. The metadata associated with the files linked to the thumbnails may be updated and uploaded to the online storage session to be applied during subsequent sessions or on other devices.

FIG. 8 illustrates computing system 801, which is representative of any system or collection of systems in which the various applications, services, scenarios, and processes disclosed herein may be implemented. Examples of computing system 801 include, but are not limited to, desktop computers, laptop computers, tablet computers, computers having hybrid form-factors, mobile phones, smart televisions, wearable devices, server computers, blade servers, rack servers, and any other type of computing system (or collection thereof) suitable for carrying out the attribute obfuscation operations described herein. Such systems may employ one or more virtual machines, containers, or any other type of virtual computing resource in the context of attribute obfuscation.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes application 806 which is representative of the software applications discussed with respect to the preceding FIGS. 1-7, including application 103 and application 133. When executed by processing system 802 to attribute obfuscation in a user interface, application 806 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device, but may also be distributed across multiple processing devices or sub-systems that cooperate in executing program instructions. Examples of processing system 802 include general purpose central processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device, but may also be implemented across multiple storage devices or sub-systems co-located or distributed relative to each other. Storage system 803 may comprise additional elements, such as a controller, capable of communicating with processing system 802 or possibly other systems.

Software 805 in general, and application 806 in particular, may be implemented in program instructions and among other functions may, when executed by processing system 802, direct processing system 802 to operate as described with respect to the various operational scenarios, sequences, and processes illustrated herein. For example, application 806 may include program instructions for implementing an attribute obfuscation process, such as obfuscation processes 200 and 300.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtual machine software, or other application software, in addition to or that include application 806. Software 805 may also comprise firmware or some other form of machine-readable processing instructions executable by processing system 802.

In general, application 806 may, when loaded into processing system 802 and executed, transform a suitable apparatus, system, or device (of which computing system 801 is representative) overall from a general-purpose computing system into a special-purpose computing system customized to perform attribute obfuscation operations. Indeed, encoding application 806 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, application 806 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 809 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 809. In some cases, the input and output devices may be combined in a single device, such as a display capable of displaying images and receiving touch gestures. The aforementioned user input and output devices are well known in the art and need not be discussed at length here.

User interface system 809 may also include associated user interface software executable by processing system 802 in support of the various user input and output devices discussed above. Separately or in conjunction with each other and other hardware and software elements, the user interface software and user interface devices may support a graphical user interface, a natural user interface, or any other type of user interface, in which a user interface to an application may be presented (e.g. user interface 105).

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. In any of the aforementioned examples in which data, content, or any other type of information is exchanged, the exchange of information may occur in accordance with any of a variety of well-known data transfer protocols. In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A computing apparatus comprising:
one or more computer readable storage media;
a processing system operatively coupled with the one or more computer readable storage media; and
an application comprising program instructions stored on the one or more computer readable storage media for rendering a user interface to the application that, when executed by the processing system, direct the processing system to at least:
identify a set of files to make available in a file selector view of the user interface to the application;
for at least a file of the set of files, identify at least an obfuscation group to which the file belongs and produce at least a representative attribute of the file as specified in metadata for the obfuscation group; and
present at least the representative attribute of the file in the file selector view in the user interface to the application.

2. The computing apparatus of claim 1 wherein to identify at least the obfuscation group associated with the file, the program instructions direct the processing system to examine metadata for the file that identifies one or more obfuscation groups to which the file belongs.

3. The computing apparatus of claim 2 wherein to produce the representative attribute of the file as specified in the metadata for the group, the program instructions direct the processing system to obscure the representative attribute.

4. The computing apparatus of claim 3 wherein the representative attribute of the file comprises a thumbnail representation of the file and wherein the metadata for the obfuscation group specifies that thumbnail representations be obscured.

5. The computing apparatus of claim 3 wherein the representative attribute comprises a file name associated with the file and wherein the metadata for the group specifies that file names be obscured.

6. The computing apparatus of claim 1 wherein the file opens in response to a selection of the representative attribute of the file and wherein the program instructions further direct the processing system to one of encrypt or obfuscate the file.

7. The computing apparatus of claim 1 wherein the application comprises a file storage application and wherein the program instructions further direct the processing system to obtain the files and the metadata for the files from an online file storage service.

8. A method for obscuring file attributes, the method comprising:
identifying a set of files to make available in a file selector view of a user interface to an application;
for at least a file of the set of files, identifying at least an obfuscation group to which the file belongs and producing at least a representative attribute of the file as specified in metadata for the obfuscation group; and
presenting at least the representative attribute of the file in the file selector view in the user interface to the application.

9. The method of claim 8 wherein identifying at least the obfuscation group associated with the file comprises examining metadata for the file that identifies one or more obfuscation groups to which the file belongs.

10. The method of claim 9 wherein producing the representative attribute of the file as specified in the metadata for the group comprises obscuring the representative attribute.

11. The method of claim 10 wherein the representative attribute of the file comprises a thumbnail representation of the file and wherein the metadata for the obfuscation group specifies that thumbnail representations be obscured.

12. The method of claim 10 wherein the representative attribute comprises a file name associated with the file and wherein the metadata for the group specifies that file names be obscured.

13. The method of claim 8 wherein the file opens in response to a selection of the representative attribute of the file and wherein the method further comprises encrypting the file.

14. The method of claim 8 wherein the application comprises a file storage application and wherein the method further comprises obtaining the files and the metadata for the files from an online file storage service.

15. A method of operating an online storage service, the method comprising:
receiving a request from an application for a set of files to make available in a file selector view of a user interface to the application;
for at least a file of the set of files, identifying at least an obfuscation group to which the file belongs and producing at least a representative attribute of the file as specified in metadata for the obfuscation group; and
communicating at least the representative attribute of the file to the application to be presented in the file selector view in the user interface.

16. The method of claim 15 identifying at least the obfuscation group associated with the file comprises examining metadata for the file that identifies one or more obfuscation groups to which the file belongs.

17. The method of claim 16 wherein producing the representative attribute of the file as specified in the metadata for the group comprises obscuring the representative attribute.

18. The method of claim 17 wherein the representative attribute of the file comprises a thumbnail representation of the file and wherein the metadata for the obfuscation group specifies that thumbnail representations be obscured.

19. The method of claim 17 wherein the representative attribute comprises a file name associated with the file and wherein the metadata for the group specifies that file names be obscured.

20. The method of claim 15 wherein the file opens in response to a selection of the representative attribute of the file and wherein the method further comprises encrypting the file.
